(19) United States
(12) Patent Application Publication
(10) Pub. No.: US 2007/0068437 A1
(43) Pub. Date: Mar. 29, 2007

(54) SYSTEM AND METHOD FOR INDICATING THE STEERING POSITION OF STEERING MEANS OF A WATERCRAFT

(76) Inventor: Greg A. Vittardi, Broadview Heights, OH (US)

Correspondence Address: TUCKER, ELLIS & WEST LLP, 1150 HUNTINGTON BUILDING, 925 EUCLID AVENUE, CLEVELAND, OH, 44115-1414, US

(21) Appl. No.: 11/534,883

(22) Filed: Sep. 25, 2006

Related U.S. Application Data
(60) Provisional application No. 60/720,341, filed on Sep. 23, 2005.

(51) Int. Cl. G05D 1/02

(52) U.S. Cl. 114/144 R

(57) ABSTRACT

The present invention is directed to system and method for indicating a steering position of the steering means of an associated watercraft. The system includes a storage unit for storing data representative of a predetermined steering position of associated steering means and means for monitoring a real-time steering position of associated steering means. Mechanical data from the monitoring means representative of the real-time steering position, is converted into electronic data and further displayed to the user with respect to the stored data representative of the predetermined steering position.

### CROSS-REFERENCE TO RELATED APPLICATIONS

This application is based on and claims priority to provisional U.S. patent application Ser. No. 60/720,341, which was filed on Sep. 23, 2005.

### BACKGROUND OF THE INVENTION

The subject application relates generally to position indicating systems and methods, and more particularly, to a system and method providing visual indication of data representative of the steering position of watercraft steering means with respect to a predetermined steering position.

Maneuvering of a watercraft is generally accomplished using a rudder or other steering device, such as an outboard motor pivot mounted on the stem of the watercraft. Determining the exact position of the steering means is often left to guess work as the orientation of the watercraft is typically the only indication of the position of the steering means. For example, docking is generally the most difficult of boating maneuvers, requiring a trial-and-error approach to determining the proper position of the rudder or outboard motor, maneuvering a boat at slow speed being very difficult. In addition to the watercraft's own momentum, drift and current play a direct part in the direction of travel of any watercraft, particularly during the docking thereof. Typically, the position of the steering means is determined by the orientation of the bow. However, under foggy conditions, or where there are no visible reference points, this method of determining a steering position is ineffective.

There is thus a need for a system and method that overcomes the above mentioned problems.

It would be desirable to have a system and method for indicating steering position of watercraft steering means that are not dependent on environmental conditions and/or existence of visible reference points when accomplishing maneuvering of a watercraft.

It would be also desirable to have a system and method for providing visual indication of data representative of the steering position of watercraft steering means.

### SUMMARY OF THE INVENTION

In accordance with the subject application, there is provided a system and method for indicating the steering position of watercraft steering means that are not dependent on environmental conditions and/or existence of visible reference points when accomplishing maneuvering of a watercraft.

Further, in accordance with the subject application, there is provided a system and method that provides visual indication of data representative of the steering position of watercraft steering means.

Still further, in accordance with one aspect of the subject application there is provided a system for indicating a steering position of associated steering means of an associated watercraft. The system includes storage means adapted for storing data representative of a predetermined steering position of associated steering means. The predetermined steering position of associated steering means, preferably, corresponds to a centerline position of an associated watercraft. The system also includes monitoring means responsive to a steering position of associated steering means and receiving means adapted for receiving data representative of a steering position of associated steering means. The system further includes display means adapted for displaying data representative of a real-time steering position of associated steering means with respect to the stored data representative of the predetermined steering position.

In a preferred embodiment, the monitoring means includes mechanical means adapted for transferring mechanical data representative of a steering position. The mechanical means is, preferably, a spring loaded cable coupled to associated steering means of an associated watercraft. The spring loaded cable is, preferably, fixedly attached to at least one moving part of associated steering means of an associated watercraft.

In another preferred embodiment, the monitoring means further includes converting means adapted for converting mechanical input from the mechanical means into electronic data representative of the steering position of associated steering means. In this embodiment, the receiving means is further adapted for receiving the electronic data representative of the steering position of associated steering means.

In yet another preferred embodiment, the monitoring means further comprises wireless means adapted for outputting electronic data representative of a real-time steering position of associated steering means. In this embodiment, the receiving means is further adapted for receiving the electronic data ouput by the wireless means.

In accordance with another aspect of the present invention, there is provided a method for indicating the steering position of associated steering means of an associated watercraft. The method begins with setting a predetermined steering position of associated steering means. Data representative of the predetermined steering position of associated steering means is then stored. The predetermined steering position, preferably, corresponds to a centerline position of an associated watercraft. Next, a real-time steering position of an associated watercraft steering means is monitored and mechanical data representative of the real-time steering position of associated steering means is produced. The mechanical data representative of the real-time steering position is further converted into electronic data. The electronic data representative of the real-time steering position of associated steering means is further received and displayed with respect to the stored data representative of the predetermined steering position.

Still other advantages, aspects and features of the present invention will become readily apparent to those skilled in the art from the following description wherein there is shown and described a preferred embodiment of this invention, simply by way of illustration of one of the best modes best suited for to carry out the invention. As it will be realized, the invention is capable of other different embodiments and its several details are capable of modifications in various obvious aspects all without departing from the scope of the invention. Accordingly, the drawings and description will be regarded as illustrative in nature and not as restrictive.

### BRIEF DESCRIPTION OF THE DRAWINGS

The accompanying drawing incorporated in and forming a part of the specification, illustrate several aspects of the present invention, and together with the description serve to explain the principles of the invention. In the drawings:

FIG. 1 is a diagram illustrating one embodiment of a system in accordance with the present invention.

FIG. 2 is a flowchart illustrating a method for indicating the steering position of associated steering means of an associated watercraft according to the subject application.

### DETAILED DESCRIPTION OF THE PREFERRED EMBODIMENT

The present invention is directed to a system and method providing real-time visual indication of data representative of the steering position of watercraft steering means with respect to a predetermined steering position. In particular, the present invention is directed to a system and method for indicating steering position of watercraft steering means that are not dependent on environmental conditions and/or existence of visible reference points when accomplishing maneuvering of a watercraft.

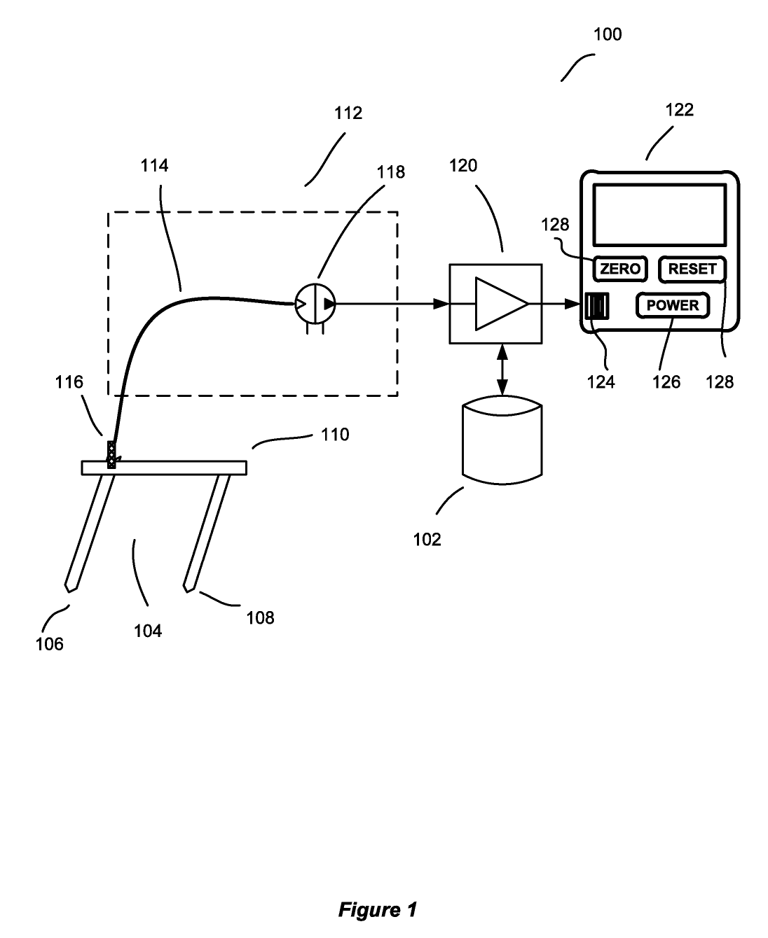

Turning now to FIG. 1, there is shown a schematic block diagram illustrating the implementation of the system 100 for indicating the steering position of watercraft steering means in accordance with the present invention. The system 100 includes storage means 102 adapted for storing data representative of a predetermined steering position of associated steering means 104. In the embodiment illustrated in FIG. 1, the steering means 104 includes a first rudder 106 and a second rudder 108 connected via a suitable linkage bar 110. Those skilled in the art will appreciate, that the steering means 104 is not limited to the exemplary embodiment presented herein. As will be recognized by a skilled artisan, the steering means 104 is capable of being implemented as any suitable means known in the art. A skilled artisan will also appreciate that the predetermined steering position of the steering means 104, preferably, corresponds to a centerline position of an associated watercraft (not shown in the drawing). The storage means 102 is capable of being a separate storage device known in the art, or is capable of being implemented as an internal storage of a suitable microprocessor. The system 100 also includes monitoring means 112 responsive to a steering position of the steering means 104. Those skilled in art will recognize that the monitoring means 112 is capable of being implemented as any suitable means known in the art. In a preferred embodiment, the monitoring means 112 includes mechanical means adapted for transferring mechanical data representative of a steering position of associated steering means.

In the embodiment of FIG. 1, the mechanical means is illustrated as a spring loaded cable 114 coupled to the associated steering means 104 of an associated watercraft. A skilled artisan will appreciate, that the spring loaded cable 114 is, preferably, fixedly attached to at least one moving part of associated steering means of an associated watercraft. For example and without limitation, when the associated steering means 104 is implemented as two rudders 106, 108 connected by the steering linkage bar 110 extending between the two rudders, as illustrated in FIG. 1, the spring loaded cable 114 is capable of being affixed to at least one of the rudders, or to the steering linkage bar through a suitable linkage clamp. In the embodiment of FIG. 1, the spring loaded cable 114 is affixed to the steering linkage bar 110 through a suitable connection known in the art, for example, but not limited to, a clamp connection 116.

The monitoring means 112 further includes converting means 118 adapted for converting mechanical input from the spring loaded cable 114 into electronic data representative of the steering position of the associated steering means 104. As will be recognized by those skilled in the art, the converting means 118 is capable of being implemented as any suitable electromechanical means known in the art capable of translating mechanical input from a mechanical means, such as a cable, into electronic control data representative of a change in position. For example and without limitation, the converting means is capable of being implemented as a wheel driven electronic converter.

It will be appreciated by those skilled in the art that the monitoring means 112 is suitably adapted to receive operating power from the power supply of the watercraft to which it is affixed. In an alternative embodiment, the monitoring means 112 draws power from any portable power supply known in the art including, without limitation, a generator, photovoltaic cells, fuel cells, chemical batteries, and the like. Preferably, to prevent damage to the sensitive electronic components of the measuring instrument, a fuse, breaker, or the like, is capable of being inserted into the power supply line, thereby preventing overload damage (not shown in FIG. 1).

The system 100 further includes receiving means adapted for receiving data representative of the steering position of associated steering means. In a preferred embodiment, as depicted in FIG. 1, the receiving means is implemented as receiving means 120 adapted for receiving electronic data. As will be understood by a skilled artisan, any suitable receiving means is capable of being used as the receiving means 120, such as a suitable microprocessor. Further included in the system 100 is display means 122 coupled to the receiving means 120 through a suitable port 124. The display means 122 is adapted for displaying data representative of the real-time steering position of the associated steering means 104 with respect to the stored data representative of the predetermined steering position. The display means 122 is capable of being, but is not limited to, a needle gauge, LED display, LCD display, and the like.

In an alternative embodiment, the monitoring means 112 further comprises wireless means (not shown in the drawing) adapted for outputting electronic data representative of a real-time steering position of associated steering means. Those skilled in the art will appreciate that the wireless means is capable of being implemented as any suitable wireless transmission means known in the art. In this embodiment, the receiving means 120 is further adapted for receiving the electronic data output by the wireless means. A skilled artisan will recognize that in this embodiment, the receiving means 120 is capable of being implemented as any suitable receiving means adapted for receiving electronic data from wireless transmission means.

Turning now to operation of the system 100 for indicating the steering position of associated steering means of an associated watercraft illustrated in FIG. 1, the operation of the system 100 commences by setting a predetermined steering position of associated steering means 104. As mentioned above, the predetermined steering position, preferably, corresponds to a centerline position of an associated watercraft. The monitoring means 112 produce mechanical data representative of the predetermined steering position of the associated steering means 104. In the preferred embodiment, this mechanical data, representative of the predetermined steering position, is transferred by the spring loaded cable 114 of the monitoring means 112 to the converting means 188.

The converting means 188 suitably convert the mechanical data into electronic data, which is suitably received by the receiving means 120. Next, data representative of the predetermined steering position of associated steering means 104 is suitably stored in the storage means 102 and displayed by the display means 122. As will be appreciated by those skilled in the art, the display means 112 is suitably adapted to graphically represent the predetermined position of the associated steering means 104. A skilled artisan will understand, that the graphical representation of the predetermined position of the steering means 104 is capable of being, for example and without limitation, a zero position.

After the predetermined position of the steering means is set, stored by the storage means 102 and displayed by the display means 122, a real-time steering position of an associated watercraft steering means is monitored by the monitoring means 112. The monitoring means 112 produce mechanical data representative of the real-time steering position of associated steering means 104. In the preferred embodiment, this mechanical data, representative of the real-time steering position, is transferred by the spring loaded cable 114 of the monitoring means 112 to the converting means 118.

The converting means 118 suitably convert the mechanical data into electronic data, which is suitably received by the receiving means 120. Next, data representative of a real-time steering position of associated steering means with respect to the stored data representative of the predetermined steering position is advantageously displayed by the display means 122. Those skilled in the art will recognize, that the display means 122 is visible to an associated user of the associated watercraft, enabling the associated user to view the real-time position of associated steering means 104 relative to the predetermined zero position.

In the preferred embodiment, the display means 122 further includes one or more user controls, suitably adapted to power on the system, reset the system, and zero the system, represented in FIG. 1 as a power key 126, reset key 128, and zero key 130. Preferably, the reset key 128 is used to reset a previously input zero position. It will be understood by those skilled in the art that the present invention is not limited to use of the user controls described above, but is further capable of including a variety of nautical controls, used in steering the watercraft. Preferably, all components of the present invention are advantageously comprised of materials suitable for use in a nautical setting, as will be understood by those skilled in the art.

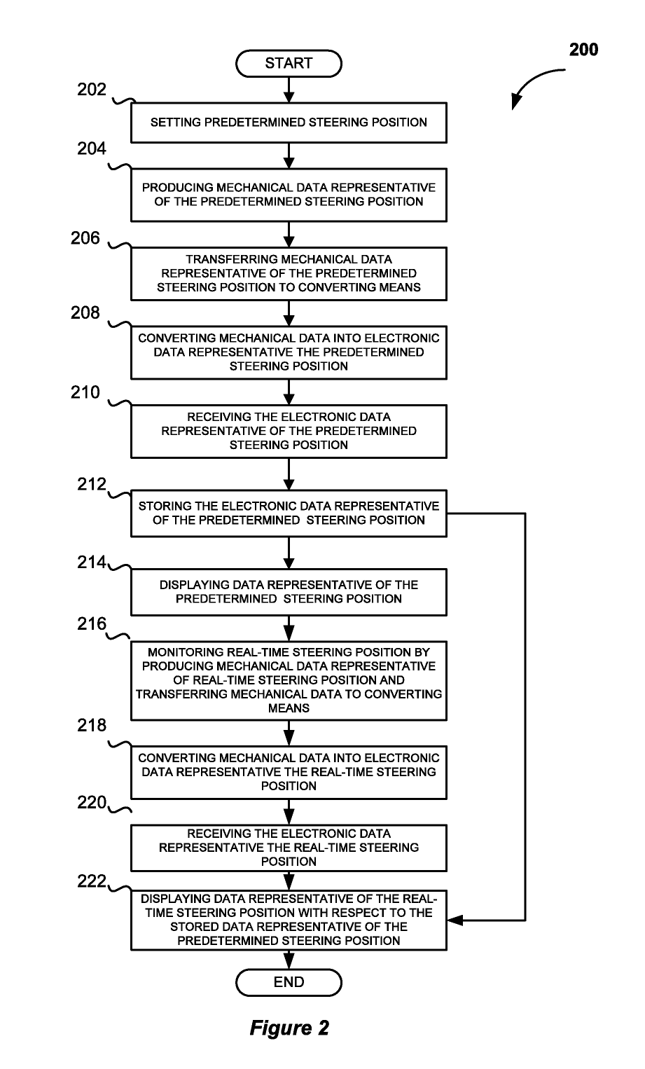

The foregoing system 100 illustrated in FIG. 1, will better be understood when viewed in conjunction with the methodologies set forth in FIG. 2. Turning now to FIG. 2, there is shown a flowchart 200 illustrating a method for indicating the steering position of associated steering means of an associated watercraft according to the subject application. Beginning at step 202, the process commences by setting a predetermined steering position of associated steering means 104. As mentioned above, the predetermined steering position, preferably, corresponds to a centerline position of an associated watercraft. Next, at step 204, mechanical data representative of the predetermined steering position of the associated steering means 104, is produced by the monitoring means 112. At step 206 mechanical data representative of the predetermined steering position of the associated steering means 104 is transferred to the converting means 118 by the spring loaded cable 114.

Flow then proceeds to step 208, at which mechanical data representative of the predetermined steering position of the associated steering means 104 is converted into electronic data by the converting means 118. At step 210 the electronic data is suitably received by the receiving means 120. Next, at step 212 the electronic data representative of the predetermined steering position of the associated steering means 104 is stored by the storing means 102 and then advantageously displayed at step 214 by the display means 122.

Flow then proceeds to step 216, at which real-time steering position of associated steering means 104 is monitored by the monitoring means 112. At step 216 mechanical data representative of the real-time steering position of associated steering means 104 is suitably produced and transferred by the spring loaded cable 114 to the converting means 118. Next, at step 218 the converting means 118 suitably convert mechanical data representative of the real-time steering position of associated steering means 104 into electronic data, which is received at step 220 by the receiving means 120.

At step 222 data representative of the real-time steering position of associated steering means 104 is displayed by the display means 122 with respect to electronic data representative of the predetermined steering position of the associated steering means 104, previously stored at step 212 by the storing means 102.

As will be appreciated by those skilled in the art, the system described herein is capable of being initially installed in a watercraft, and is also capable of being retrofitted onto an existing watercraft. It will be evident to a skilled artisan that the present invention is not limited to a watercraft of any particular tonnage. The system of the present invention is capable of being installed on small vessels with inboard/outboard engines, as well as large vessels with inboard drive trains and rudders. It is also capable of being used on sailboats or large ships.

The invention extends to computer programs in the form of source code, object code, code intermediate sources and object code (such as in a partially compiled form), or in any other form suitable for use in the implementation of the invention. Computer programs are suitably standalone applications, software components, scripts or plug-ins to other applications. Computer programs embedding the invention are advantageously embodied on a carrier, being any entity or device capable of carrying the computer program: for example, a storage medium such as ROM or RAM, optical recording media such as CD-ROM or magnetic recording media such as floppy discs. The carrier is any transmissible carrier such as an electrical or optical signal conveyed by electrical or optical cable, or by radio or other means. Computer programs are suitably downloaded across the Internet from a server. Computer programs are also capable of being embedded in an integrated circuit. Any and all such embodiments containing code that will cause a computer to perform substantially the invention principles as described, will fall within the scope of the invention.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally and equitably entitled.

What is claimed:

1. A system for indicating a steering position of associated steering means of an associated watercraft comprising:
storage means adapted for storing data representative of a predetermined steering position of associated steering means;
monitoring means responsive to a steering position of associated steering means;
receiving means adapted for receiving data representative of a steering position of associated steering means; and
display means adapted for displaying data representative of a real-time steering position of associated steering means with respect to the stored data representative of the predetermined steering position.

2. The system for indicating a steering position of associated steering means of claim 1, wherein the predetermined steering position of associated steering means corresponds to a centerline position of an associated watercraft.

3. The system for indicating a steering position of associated steering means of claim 1, wherein the monitoring means comprises mechanical means adapted for transferring mechanical data representative of a steering position.

4. The system for indicating a steering position of associated steering means of claim 3, wherein the mechanical means is a spring loaded cable coupled to associated steering means of an associated watercraft.

5. The system for indicating a steering position of associated steering means of claim 4, wherein the spring loaded cable is fixedly attached to at least one moving part of associated steering means of an associated watercraft.

6. The system for indicating a steering position of associated steering means of claim 3, wherein the monitoring means further comprises converting means adapted for converting mechanical input from the mechanical means into electronic data representative of a real-time steering position of associated steering means, and wherein the receiving means is further adapted for receiving the electronic data.

7. The system for indicating a steering position of associated steering means of claim 6, wherein the monitoring means further comprises wireless means adapted for outputting electronic data representative of a real-time steering position of associated steering means, and wherein the receiving means is further adapted for receiving the electronic data output by the wireless means.

8. A method for indicating a steering position of associated steering means of an associated watercraft comprising:
setting a predetermined steering position of associated steering means;
storing data representative of the predetermined steering position of associated steering means;
monitoring a real-time steering position of an associated watercraft steering means;
receiving data representative of the real-time steering position of associated steering means; and
displaying data representative of the real-time steering position of associated steering means with respect to the stored data representative of the predetermined steering position.

9. The method for indicating the steering position of associated steering means of claim 7 wherein the step of monitoring comprises producing mechanical data representative of the real-time steering position of associated steering means.

10. The method for indicating a steering position of associated steering means of claim 7 wherein the step of monitoring further comprises converting mechanical data into electronic data representative of the real-time steering position of associated steering means, and wherein the step of receiving further comprises receiving the electronic data.

11. The method for indicating a steering position of associated steering means of claim 6 wherein the predetermined steering position of associated steering means corresponds to a centerline position of an associated watercraft.
